(19) United States
(12) Patent Application Publication
(10) Pub. No.: US 2017/0167460 A1
(43) Pub. Date: Jun. 15, 2017

(54) Start Light

(71) Applicant: Jeffrey D. Starkey, Beardstown, IL (US)

(72) Inventor: Jeffrey D. Starkey, Beardstown, IL (US)

(21) Appl. No.: 14/969,059

(22) Filed: Dec. 15, 2015

(51) Int. Cl. F02N 11/08; G08B 5/36; G08B 21/18

(52) U.S. Cl. CPC F02N 11/0807; G08B 21/18; G08B 5/36

(57) ABSTRACT

The present invention discloses a system and apparatus for remotely starting automobiles. The invention provides a remote starter or a key fob connected with different components of the automobile. The remote starter is provided with an additional feature of LED light indicator to confirm the ignition of the engine using the remote starter. The remote starter also includes a computer chip to establish a communication between the remote starter and the automobile.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of the Invention

The present invention relates to the field of remote engine starters, and, more particularly, to remote starters for automotive vehicles that have onboard indicator lights to indicate the start-up of the vehicle.

(2) Background of the Invention

Remote controls are widely used to operate television sets, videocassette recorders, digital video players, radios, compact discs, audio tape players, and many other audio and video components and systems. Remote control systems have also been used for decades to control many devices beyond the standard fare of entertainment systems. For example, remote control systems can be used to operate model airplanes, railroad locomotives, boats, cars, and other toys. Remote controls can also be used to exercise functions of security systems, including vehicle and home security systems. Many other remote control applications can be thought of, including control of generators and smart homes. In general, a remote control system includes a remote controller, or simply a remote control, and a device controlled or operated by the remote control. Thus, a remote control is a device or implement through which the operation of one or more systems can be controlled by transmission of control information. It is a device for controlling the operation of the system or systems, as distinguished from a device used solely for transmitting authentication or transaction selection and authorization data.

Engines, and especially internal combustion engines, are extensively employed to operate consumer machines, such as automobiles, lawn mowers, and industrial machinery, such as cranes and lifts. Engines are also common in industrial settings, such as irrigation systems and oil well systems.

It is advantageous, in many circumstances, to start an automobile engine or accessory, such as an air conditioner or heater, by remote means from the user's residence or business. Beyond general convenience and comfort for the user during the remote start, a pre-cooling or pre-warming period is particularly advantageous for the elderly, infants, and those with poor or sensitive health, so that they may enter into a tolerable atmosphere. Additionally, in the winter, a warm-up period would facilitate the manual removal of ice and snow from the automobile's exterior.

Various prior arts have disclosed remote-controlled automated systems for automobiles. Patent No US 20130297194 A1 discloses systems and method for remote starting of a vehicle equipped with smart start system that includes a system for remote starting a vehicle equipped with a keyless go system. U.S. Pat. No. 5,942,988 A discloses a remote starter that includes a receiver for receiving wireless signals and a controller coupled to the receiver and the engine ignition. Similarly, other prior arts, such as U.S. 4,674,454 A, U.S. Pat. No. 5,024,186 A, and U.S. Pat. No. 5,673,017 A, disclose various types of remote controlled automobiles used for the automatic start-up of automobiles. Automotive remote starters are commonly available and are used for various other purposes as well, including anti-theft and anti-carjacking device, as disclosed in WO 1998031575 A1. All of the prior art systems and apparatus suffer from disadvantages that they are complicated, expensive, and/or not easily transferred between vehicles or equipment to which they are to be applied.

### SUMMARY

In view of the foregoing disadvantages inherent in the known types of remote starters present in the prior art, the present invention provides a new and improved remote controlled way of auto-starting of an automobile, such as cars, etc. using key fob. As such, the general purpose of the present invention, which will be described subsequently in greater detail, is to provide a new and improved system and method for auto-starting of automobiles that has all the advantages of the prior art and none of the disadvantages.

An objective of the invention is to provide an improved system and apparatus for remote assisted activation and deactivation of an automobile for starting up the automobile with keyless feature.

It is another objective of the present invention to provide a system and apparatus for remote assisted starter of an automobile, provided with a LED light indicator to confirm the ignition of the engine.

It is also an objective of the present invention to provide an improved system and method that includes a computer chip in the key fob to interact with the automobile and guide the activation of the ignition of the engine.

Furthermore, it is an objective of the present invention to provide a system that is much more flexible and economical to use and can be utilized in all kinds of moving vehicles.

There has thus been outlined, rather broadly, the more important features of the invention in order that the detailed description thereof that follows may be better understood, and in order that the present contribution to the art may be better appreciated.

Numerous objectives, features, and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments, and of being practiced and carried out in various ways. Also, it is to be understood that the phraseology and terminology employed herein are for the purpose of description, and should not be regarded as limiting.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 is a perspective view of the present invention.

### DETAILED DESCRIPTION OF THE INVENTION

The embodiments of the present disclosure, described below, are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention, and, together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

In some preferred embodiments, the present invention provides a remote starter for automobiles to provide keyless ignition to the engine for easy and convenient startup of an automobile in all kind of weather conditions. The purpose of the invention is to provide a user friendly, easy to use remote starter.

This section summarizes some aspects of the present disclosure and briefly introduces some preferred embodiments. Simplifications or omissions in this section, as well as in the abstract or the title of this description, may be made to avoid obscuring the purpose of this section, the abstract, and the title. Such simplifications or omissions are not intended to limit the scope of the present disclosure, nor imply any limitations.

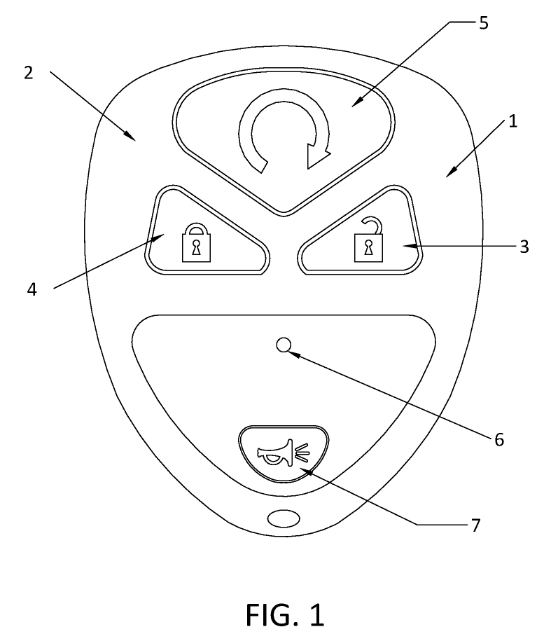

Generally speaking, this invention discloses a system and method for remotely starting automobiles. With reference to FIG. 1, the present invention provides an enclosed housing 1 carrying multiple features for operating a vehicle. The enclosed housing 1 includes a strong filler material base 2 for holding different keys in order to remotely operate the automobile. The base 2 includes different keys; unlock key 3, a lock key 4, a reverse arrow key 5, a LED light indicator 6 and a speaker key 7. These keys are provided in key fob for remotely operating and controlling the automobile. The unlock key 3 when pressed will unlock all the locks of different doors of the automobile, the lock key 4 will lock all the doors to restrict the entry, reverse key 5 is to reverse the action performed, LED light indicator is an added feature of the present invention in the existing key fobs to indicate the activation or deactivation of the ignition of the engine, and speaker key 7 to alert about the unauthorized usage.

According to the present invention, a system for use in selectively operating components of a vehicle includes components that are controlled by a vehicle computer. The system includes a unit remote from the vehicle that has an input device for providing signals indicative of the remote unit identification and a desired operational state of the vehicle components. A controller generates command signals from the input signals and further generates, from decoded status signals, signals indicative of the operational state of the vehicle components. The system also includes a unit affixed to the vehicle that has a receiver for decoding received command signals and a mechanism configured with the vehicle components that provides signals indicative of the operational state of those components and also signals indicative of the vehicle unit identification. A controller provides component status signals from the operational state and identification signals, and generates for the components control signals, which are dependent on the received command signals. A mechanism is included for operating the vehicle components in dependence on the control signals.

In its preferred embodiment, the present invention provides a remote control vehicle starter that is simple and inexpensive in construction. Furthermore, the present invention provides a remote starter system for a vehicle that is operable to start the vehicle ignition via a remote transmitter or key fob the like. The remote starter system includes a control or control unit or module at the vehicle that receives the transmitted signal and activates or energizes or starts the vehicle ignition. The control may communicate with one or more signals to the remote transmitter or key fob to notify the user that the vehicle ignition has been actuated. In an embodiment, such notifications can be transmitted and received in the form of LED light indicators provided on the key fob that will notify the user about the ignition of the engine of the automobile.

Other features of the invention include a computer chip provided in the key fob or like to communicate with the components of the automobile to remote start the automobile and provide an indicator about the ignition of the engine.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

I/We claim:

1. A system and apparatus for remote starter of an automobile comprising:
(a) a key fob or remote starter connected to the automobile sensing circuits which electrically sense pre-determined conditions of said automobile;
(b) an indicating means fir receiving signal about pre-determined conditions to ensure the installation of the said key fob or remote starter;
(c) communication medium to transmit the signals from automobile to the key fob or remote starter

2. The apparatus as claimed in claim 1, wherein said indicating means is a light emitting diode.

3. The apparatus as claimed in claim 1, wherein said communication medium is a computer chip embedded in the key fob or remote starter to communicate and transfer the signals.

4. A system for selectively operating components of a vehicle comprising:
(a) vehicular components controlled by a vehicle computer;
(b) a remote unit that includes input device for providing signals indicative of the remote unit identification and a desired operational state of the vehicle components;
(c) a controller to generate command signals from input signals and further generate signals indicative of operational state of the vehicle components

5. The system as claimed in claim 4, wherein the system includes a unit affixed to the vehicle that has a receiver for decoding received command signals and a mechanism configured with the vehicle components.

6. A remote starter system for a vehicle that is operable to start the vehicle ignition via a remote transmitter or key fob the like.

7. The remote starter system as claimed in claim 6, wherein the system includes a control or control unit or module at the vehicle that receives the transmitted signal and activates or energizes or starts the vehicle ignition.

8. The remote starter system as claimed in claim 6, wherein the control may communicate one or more signals to the remote transmitter or key fob to notify the user that the vehicle ignition has been actuated

9. The remote starter system as claimed in claim 6, wherein the notifications can be transmitted and received in the form of LED light indicators provided on the key fob that will notify the user about the ignition of the engine of the automobile.
